(19) United States
(12) Patent Application Publication
(10) Pub. No.: US 2024/0266853 A1
(43) Pub. Date: Aug. 8, 2024

(54) PORTABLE POWER BANK

(71) Applicant: Yi-Kai SHEN, Taichung City (TW)

(72) Inventor: Yi-Kai SHEN, Taichung City (TW)

(21) Appl. No.: 18/228,953

(22) Filed: Aug. 1, 2023

(30) Foreign Application Priority Data
Feb. 6, 2023 (TW) 112201027

(51) Int. Cl. H02J 7/00; H01M 10/42; H01M 50/247; H01M 50/262; H02J 50/10; H04M 1/72412

(52) U.S. Cl. CPC H02J 7/0044; H01M 10/425; H01M 50/247; H01M 50/262; H02J 50/10; H04M 1/72412; F16M 13/005; G06F 3/1454; H01M 2010/4278; H04N 23/632

(57) ABSTRACT

A portable power bank, which is to be coupled with a mobile device having a screen, includes a housing, a battery, a display, and a signal receiving module. The housing has a front side and a back side to be coupled with the mobile device. The battery is disposed inside the housing for charging the mobile device. The display is disposed at the front side of the housing. The signal receiving module is electrically connected with the display. The signal receiving module wirelessly receives a signal transmitted by the mobile device to enable the display to show a mirror image of an image of the screen of the mobile device. In this way, the portable power bank can show the mirror image of the screen image of mobile devices of different brands and charge the mobile devices.

### BACKGROUND OF THE INVENTION

### 1. Field of the Invention

The present invention relates generally to mobile devices, especially a portable power bank with mirror display function.

### 2. Description of the Related Art

Mobile devices, such as mobile phones and tablet computers, are generally equipped with rear lens, and most mobile devices are equipped with front lens to facilitate users to take selfies. However, due to cost or manufacturing technology considerations, the shooting quality and focal length range of the front lens of most mobile devices are not as good as the rear lens. Therefore, many users who pursue image quality will take selfies with the rear lens. However, the images captured by the rear lens are displayed on the screen opposite to the rear lens, so users cannot accurately catch the viewing range of the lens, resulting in inconvenience in use.

In order to allow users to catch the viewing range more accurately, there is currently a solution of attaching a small mirror to the back of the mobile device. Although this way may improve the above-mentioned defect, it can only roughly catch the viewing range. Another solution is to fix a smart watch on the back of the mobile device. By means of using the display screen of the watch to display synchronously with the mobile device, the viewing image of the rear lens can be displayed on the watch. Although this way can accurately display the viewing range, the users need to purchase a smart watch, which is not only expensive, but also may encounter a problem that smart watches of different brands cannot be paired with mobile devices of specific brands. As such, this solution is still inconvenient to use.

In another aspect, the functions of mobile devices of nowadays are becoming more and more powerful, and users frequently use various functions of the mobile device to make the battery life insufficient. Especially, when taking pictures or recording videos, if the power is insufficient, it will be difficult to capture fleeting brilliant moments.

### SUMMARY OF THE INVENTION

The present invention has been accomplished in view of the above-noted circumstances. It is an objective of the present invention to provide a portable power bank, which can display mirror image of the screen image of the mobile devices of different brands, and can charge the mobile devices.

To attain the above objective, the present invention provides a portable power bank, which is adapted to be coupled with a mobile device having a screen, and comprises a housing, a battery, a display, and a signal receiving module. The housing has a front side and a back side. The back side is adapted to be coupled with the mobile device. The battery is disposed inside the housing for charging the mobile device. The display is disposed at the front side of the housing. The signal receiving module is electrically connected with the display. The signal receiving module is configured to wirelessly receive a signal transmitted by the mobile device to enable the display to show a mirror image of an image of the screen of the mobile device. In this way, the portable power bank can show the mirror image of the screen image of mobile devices of different brands, and charge the mobile devices.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view showing that a portable power bank according to an embodiment of the present invention is coupled with a mobile device;

FIG. 2 is a perspective view of the portable power bank of the embodiment of present invention;

FIG. 3 is an exploded view of the portable power bank of the embodiment of the present invention;

FIG. 4 is a cross-sectional view taken along line 4-4 of FIG. 1; and

FIGS. 5 and 6 are schematic views showing the portable power bank of the embodiment of the present invention in different states of use.

### DETAILED DESCRIPTION OF THE INVENTION

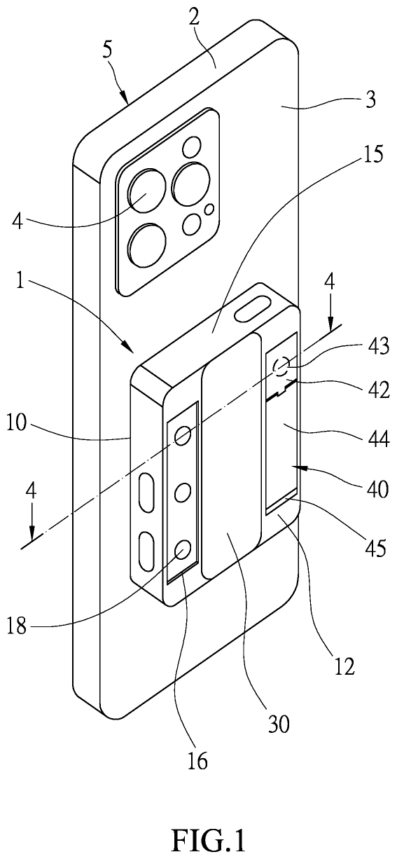

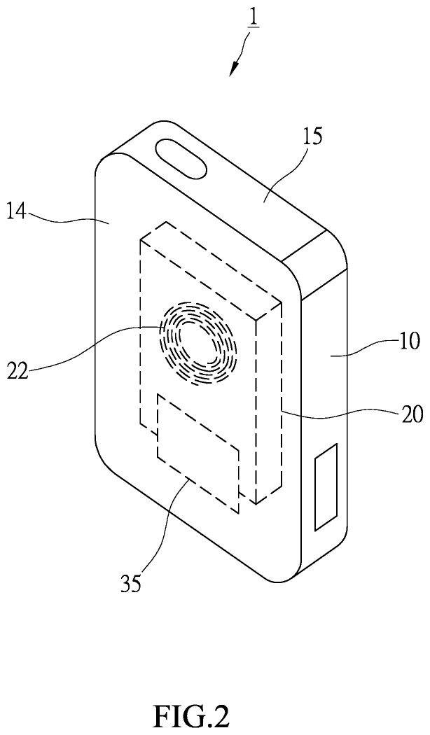

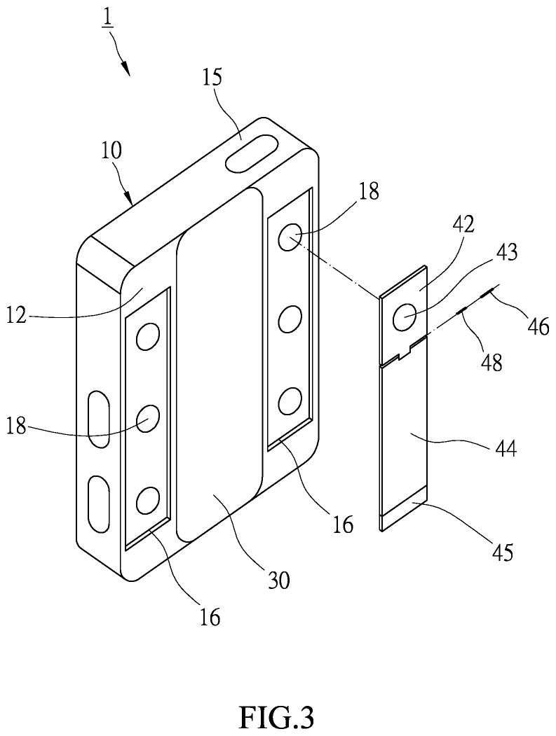

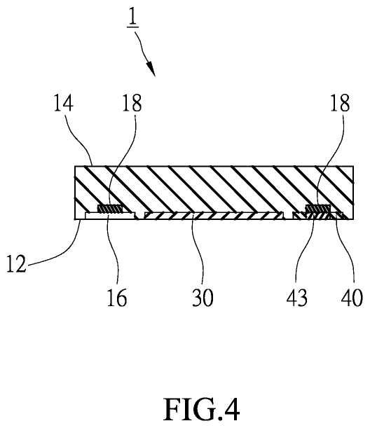

The structure and technical features of the present invention will be detailedly described hereunder by an embodiment and accompany drawings. As shown in FIGS. 1-4, a portable power bank 1 provided in accordance with an embodiment of the present invention is adapted to be coupled with a mobile device 2, such as a mobile phone or tablet computer. The portable power bank 1 is composed of a housing 10, a battery 20, a display 30, a signal receiving module 35, and optionally a support stand 40.

The housing 10 is a flat cube and has a front side 12, a back side 14, and a peripheral side 15. The back side 14 of the housing 10 is used to be coupled with the back 3 of the mobile device 2 by magnetic attraction, anchored engagement, or other proper ways. On the front side 12 o the housing 10, two elongated recesses 16 are provided. In each of the recesses 16, three first magnetic members 18 are embedded. In another embodiment, the recess 16 may not be provided or only one recess 16 may be provided, and the location of the recess 16 may be changed to the periphery side 15. Further, the first magnetic members 18 may be omitted, or one or more magnetic members 18 may be provided, and the location of the magnetic member 18 may be changed to the periphery side 15.

The battery 20 is located inside the housing 10 and capable of charging the mobile device 2. A charging coil 22 is further provided inside the housing 10 in a way that the charging coil 22 is electrically connected with the battery 20, so that the portable power bank 1 can charge the mobile device 2 in a wireless manner. In another embodiment, the portable power bank 1 will charge the mobile device 2 via an electrical wire.

The display 30 is arranged on the front side 12 of the housing 10 and located between the two recesses 16. The display 30 has a width ranging from 32 mm to 56 mm, and a length ranging from 66 mm to 99 mm, such that the aspect ratio of the display 30 is similar to that of the screen 5 of the mobile device 2.

The signal receiving module 35 is installed inside the housing 10 and electrically connected to the display 30. The signal receiving module 35 is configured to be capable of receiving the signal transmitted by the mobile device 2 in a wireless manner in such a way that the display 30 shows a mirror image of an image of the screen 5 of the mobile device 2. The so-called mirror image in the present invention refers to a reverse image in left and right sides. In another embodiment, the signal receiving module 35 can be disposed outside the housing 10.

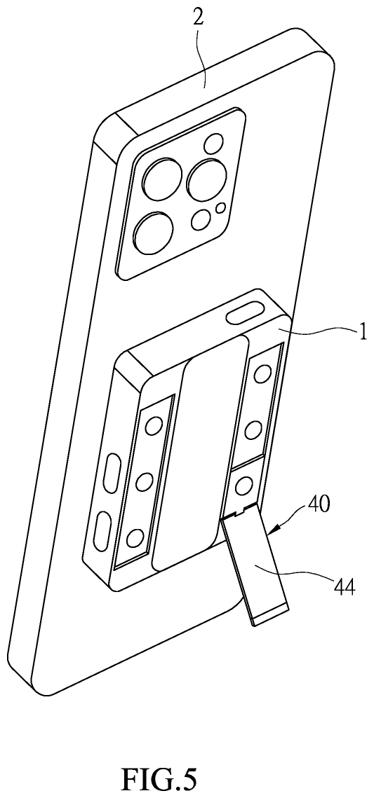

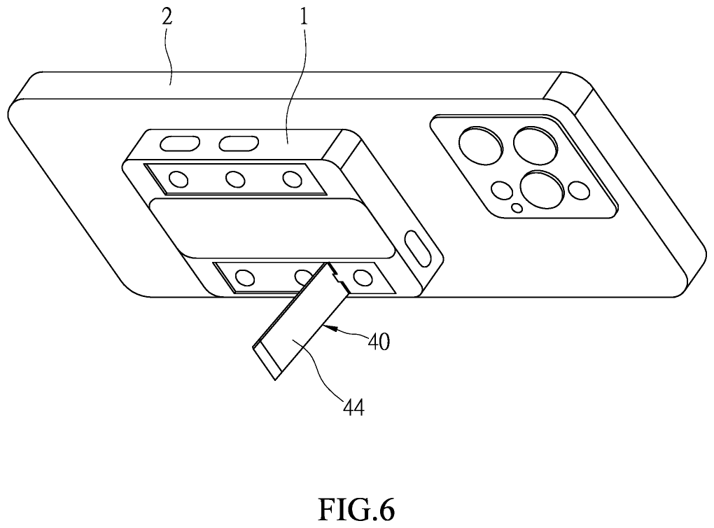

The support stand 40 is accommodated in one of the recesses 16. The support stand 40 has an abutment portion 42 attracted to the first magnetic members 18, and a support portion 44 that can be moved or bent relative to the abutment portion 42 to change an orientation angle relative to the abutment portion 42. The support portion 44 is pivotally connected to the abutment portion 42 by a pivot 46. A spring 48 is sleeved onto the pivot 46 and arranged between the abutment portion 42 and the support portion 44 in such a way that the support portion 44 can set at a desired angle, such as 30°, 45°, 60°, 75°, 90°, 120°, 135°, 150° or 180°, relative to the abutment portion 42. The abutment portion 42 may be made of a material that can be attracted by the first magnetic members 18, such as iron alloy. In order to enhance the magnetic attraction, the abutment portion 42 may be provided with a second magnetic member 43 that can be magnetically attracted to the first magnetic members 18. The abutment portion 42 is square, so it can still be accommodated and fitted into the recess 16 after being rotated by 90°. When the user wants to stand the mobile device 2 on the table and watch it, he/she can attach the abutment portion 42 to any of the first magnetic members 18, and then adjust the orientation angle between the support portion 44 and the abutment portion 42 and make the terminal end of the support portion 44 stand on the desktop, so that the mobile device 2 can be held at an appropriate angle for easy viewing. As shown in FIGS. 5 and 6, the mobile device 2 can be firmly positioned at an upright or transverse posture. In order to avoid sliding, an anti-slip member 45 may be provided at a terminal end of the support portion 44, and the anti-slip member 45 can be made of rubber, polymer, or other materials, which can make the positioning of the mobile device 2 more reliable. When the support stand 40 is folded, the outer surfaces of the abutment portion 42 and the support portion 44 are flush with the front side 12 of the housing 10. As a result, the appearance of the portable power bank 1 is very smooth, and the support stand 40 is not easy to be caught by foreign objects to fall off.

Since the signal receiving module 35 is configured being capable of receiving signals from mobile devices 2 of different brands, the user does not need to buy a smart watch of the same brand as the mobile device 2. By using the portable power bank 1 to pair a mobile device 2 of various brands and then enable the display 30 to show a mirror image of the screen 5 of the mobile device 2, the display 30 can display the accurate viewing range when the user uses the rear lens 4 to take a selfie, which makes the view taking very convenient for the user.

In addition, the portable power bank 1 can charge the mobile device 2 in a wired or wireless manner, which can greatly reduce the risk of power shortage when the user wants to take pictures or record videos.

It is to be especially mentioned that most of the monitors with mirror display function on the market are large-sized TVs, and are not applied to small-sized displays like the present invention. The portable power bank of the present invention integrates many functions, such as mirror display, wired/wireless charging, and a stand, and thus has great market potential.

Based on the technical features of the present invention, various modifications to the portable power bank 1 may be made. For example, the abutment portion 42 and the support portion 44 of the support stand 40 can be coupled by other ways, and the orientation angle therebetween may be adjusted in a continuous manner, not a discrete manner. Such variations are not to be regarded as a departure from the spirit and scope of the invention, and all such modifications as would be obvious to one skilled in the art are intended to be included within the scope of the following claims.

What is claimed is:

1. A portable power bank for being coupled with a mobile device comprising a screen, the portable power bank comprising:
a housing having a front side and a back side, the back side being adapted to be coupled with the mobile device;
a battery disposed inside the housing for charging the mobile device;
a display disposed at the front side of the housing;
a signal receiving module electrically connected with the display;
wherein the signal receiving module wirelessly receives a signal transmitted by the mobile device to enable the display to show a mirror image of an image of the screen of the mobile device.

2. The potable power bank as claimed in claim 1, wherein the housing is provided with at least one first magnetic element.

3. The portable power bank as claimed in claim 2, wherein the first magnetic member is provided at the front side of the housing.

4. The portable power bank as claimed in claim 2, wherein the housing is provided with a recess in which the first magnetic member is located.

5. The portable power bank as claim in claim 4, further comprising a support stand; the support stand comprises an abutment portion mounted to the housing, and a support portion moveable relative to the abutment portion to change an orientation angle between the abutment portion and the support portion.

6. The portable power bank as claimed in claim 5, wherein the abutment portion of the support stand is magnetically attracted to the first magnetic member.

7. The portable power bank as claimed in claim 5, wherein the support portion of the support stand is provided at a terminal end thereof with an anti-slip member.

8. The portable power bank as claimed in claim 5, wherein the support stand comprises a spring disposed between the abutment portion and the support portion.

9. The portable power bank as claimed in claim 4, further comprising a support stand disposed in the recess; the support stand comprises an abutment portion magnetically attracted to the first magnetic member, and a support portion moveable relative to the abutment portion to change an orientation angle between the abutment portion and the support portion.

10. The portable power bank as claimed in claim 9, wherein the abutment portion of the support stand is provided with a second magnetic member attracted to the first magnetic member.

11. The portable power bank as claimed in claim 9, wherein the support stand comprises a spring disposed between the abutment portion and the support portion.

12. The portable power bank as claimed in claim 1, further comprising a charging coil electrically connected with the battery for enabling the portable power bank to charge the mobile device.

13. The portable power bank as claimed in claim 1, wherein the display has a width ranging from 32 mm to 56 mm, and a length ranging from 66 mm to 99 mm.
